(19) United States
(12) Patent Application Publication
(10) Pub. No.: US 2011/0090921 A1
(43) Pub. Date: Apr. 21, 2011

(54) NETWORK ABSTRACTION LAYER (NAL)-AWARE MULTIPLEXER

(76) Inventors: Shemimon Manalikudy Anthru, Dayton, NJ (US); David nthony Campana, Princeton, NJ (US); Avinash Sridhar, Plainsboro, NJ (US)

(21) Appl. No.: 12/737,252

(22) PCT Filed: Jan. 27, 2009
(86) PCT No.: PCT/US2009/000515

§ 371 Date: Dec. 22, 2010

Related U.S. Application Data
(60) Provisional application No. 61/077,185, filed on Jul. 1, 2008.

(51) Int. Cl. H04J 3/22

(52) U.S. Cl. 370/465

(57) ABSTRACT

A multiplexer applies dynamic bit rate reduction at the multiplexer level in accordance with the types of video input streams as determined from information contained in units of the video input streams. The multiplexer parses the Network Abstraction Layer (NAL) headers of said units to determine their relative importance and passes them on to its output accordingly. The multiplexer can also take advantage of the relation between streams if they are related, as in the case of Scalable Video Coding (SVC).

### CROSS-REFERENCE TO RELATED APPLICATIONS

This application claims the benefit of U.S. Provisional Application No. 61/077,185, filed Jul. 1, 2008.

### FIELD OF THE INVENTION

The present invention relates to the field of digital video transmission, and particularly to the multiplexing of digital video streams.

### BACKGROUND INFORMATION

A statistical multiplexer is used in a media broadcast server to combine multiple input streams to transmit over a single output pipe having a maximum bandwidth limit. The input streams will be of variable bit rate since the bit rates of the media encoders generating the streams will depend on variations in the sources, such as, for example, video scene changes.

Statistical multiplexers use different techniques to accommodate input streams having variable bit rates in the constant bit rate output. Most of the techniques currently used will have an impact on the quality of the stream. One of the methods used by statistical multiplexers is to divide the output communication channel into an arbitrary number of variable bit rate digital channels. Each digital channel will be allocated according to the instantaneous traffic demand of the input streams. This kind of output link sharing provides a means to satisfy the variable bit rate needs of the input streams at different instants of time. If a large number of input streams are in need of high throughput at the same time, however, such link sharing often fails. In this situation, not all of the input streams will be able to get the bandwidth they require, and quality is sacrificed in order to accommodate the fixed bandwidth output.

FIGS. 1A and 1B illustrate a typical link sharing arrangement, in which a 7 Kbps output channel is divided into four logical channels having bit rates of 1 Kbps, 3 Kbps, 2 Kbps and 1 Kbps, respectively, as shown in FIG. 1B. Two variable bit rate input streams averaging 5 Kbps and 2 Kbps are shown in FIG. 1A. As illustrated, in the first cycle (0-1,000 ms) the multiplexer can make use of all logical channels and put all input streams into the output pipe, whereas in the second cycle (1,000-2,000 ms) the input bit rate is more than the capacity of the available logical channels.

In typical broadcast systems, such as in direct broadcast satellite applications, multiple video programs are encoded in parallel, and the digitally compressed bit streams are multiplexed into a single, constant bit rate channel. The simplest multiplexing approach to this application is to divide the available channel bandwidth equally among all programs. But this method has the disadvantage that at any instant in time, the resulting quality of the video programs is uneven because of the different scene content of the programs and changes of scene content over time. The explanation for this lies in rate-distortion theory. (See T. Berger, Rate Distortion Theory, Prentice-Hall, Inc.)

To achieve equal video quality for all programs, the available channel bandwidth should be distributed unevenly among the programs, specifically, in proportion to the information content (e.g. complexity) of each of the audio/video sources. Thus an objective of statistical multiplexing is to dynamically distribute the available channel bandwidth among the video programs in order to maximize the overall picture quality of the system.

There are several methods that attempt to achieve the above-described objective, one of which is referred to as joint rate-control, which guides the operation of individual encoders based on a continuous monitoring of the scene content of each of the video sources. (See Statistical multiplexing using MPEG-2 video encoders, https://www.research.ibm.com/journal/rd/434/boroczky.txt)

There are two known ways of doing joint rate-control. One is a feedback-based approach, in which statistical measurements of video complexity are generated by the encoders as a by-product of the compression process. The statistics from all encoders are compared and used to control the bit allocation for the subsequent video. Another is a look-ahead approach, in which the complexity statistics are computed by preprocessing all video programs prior to encoding. These statistics are then used to more accurately predict the bit rate allocation needed for optimum compression of the video sources in the rate distortion sense.

There are disadvantages in joint rate-control, however. Regardless of the approach taken, joint rate-control changes the encoder bit rate dynamically at Group of Pictures (GOP) boundaries. Because joint rate-control controls each encoder individually, in a multi-program environment where there is relative dependency between streams (for example, a Scalable Video Coding (SVC) stream where the base and enhancement layers are related), joint rate-control does not take advantage of the relation between layers. Moreover, joint rate-control depends on the statistics produced by different approaches, but finding the best statistics to describe the complexity of a program is a challenging task.

As such, there is a need for a statistical multiplexer that can better accommodate input streams having variable bit rates with less impact on the quality of the streams.

### SUMMARY OF THE INVENTION

In accordance with the principles of the invention, a multiplexer applies dynamic bit rate reduction at the multiplexer level in accordance with the types of video input streams as determined from information contained in the headers of units of the video input streams. The multiplexer parses the headers of Network Abstraction Layer (NAL) units to determine the units' relative importance, selects the more important units, and passes the selected units on to its output. The multiplexer can also take advantage of any relationship that may exist between streams, as may occur with Scalable Video Coding (SVC).

The aforementioned and other features and aspects of the present invention are described in greater detail below.

### BRIEF DESCRIPTION OF THE DRAWINGS

FIGS. 1A and 1B illustrate a conventional link sharing arrangement.

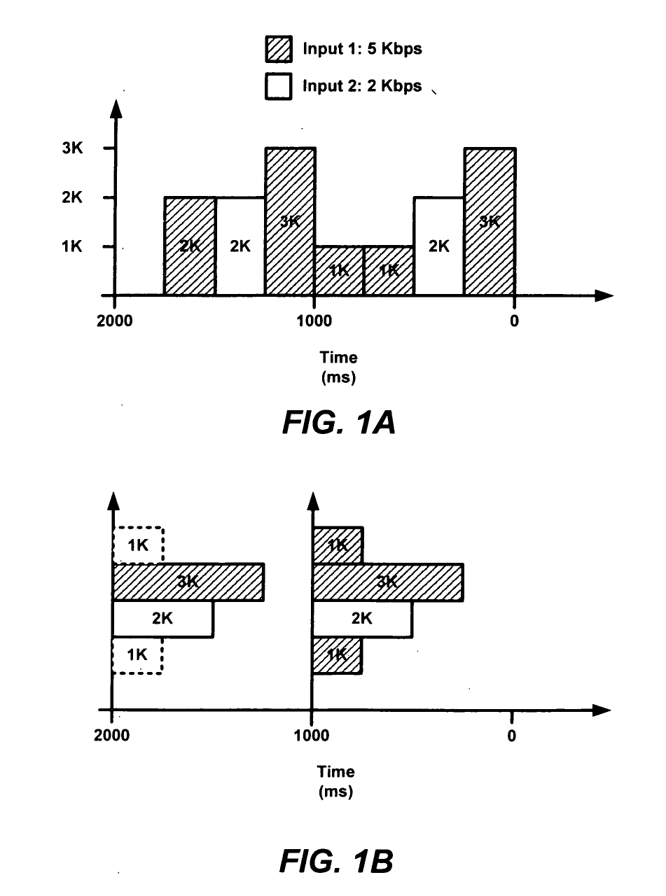

FIGS. 2A and 2B illustrate the structure of Network Abstraction Layer (NAL) units.

FIG. 3 illustrates the operation of an exemplary embodiment of a statistical multiplexer system in accordance with the present invention in a characteristic operating scenario.

FIG. 4 is a flow chart illustrating the operation of an exemplary embodiment of a multiplexer in accordance with the present invention.

### DETAILED DESCRIPTION

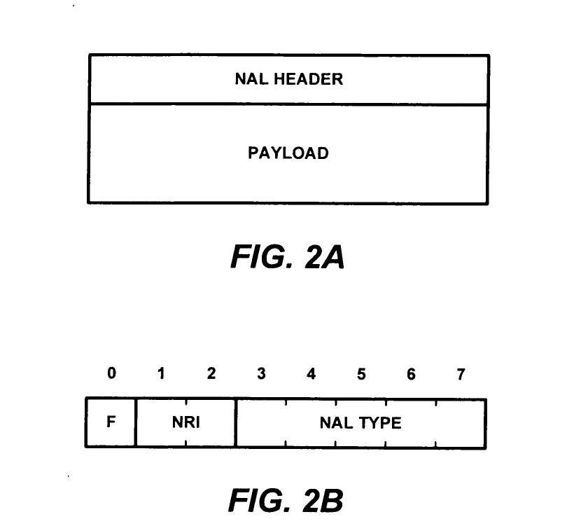

As is well known, H264/Advanced Video Coding (AVC) bit streams are transported as Network Abstraction Layer (NAL) units. (See RTP Payload Format for H.264 Video, RFC 3984, February 2005.) Each NAL unit has a NAL header which describes the NAL type. The general structure of a NAL unit is shown in FIG. 2A. A NAL header is shown in FIG. 2B. As shown in FIG. 2B, the header contains a five-bit NAL TYPE field, which indicates the NAL unit type value, a two-bit NAL_ref_idc (NRI) field, and an eighth, forbidden zero bit F.

Per RFC 3984, the two-bit NAL_ref_idc field indicates a priority value for the NAL unit. A value of 00, for instance, indicates that the content of the NAL unit is not used to reconstruct reference pictures for inter-picture prediction. Such NAL units can be discarded without risking the integrity of the reference pictures. Values greater than 00 indicate that the decoding of the NAL unit is required to maintain the integrity of the reference pictures. Also per RFC 3984, a value of 0 for the F bit indicates that the NAL unit type octet and payload should not contain bit errors or other syntax violations. A value of 1 indicates that the NAL unit type octet and payload may contain bit errors or other syntax violations. The decoder may react accordingly.

In an exemplary embodiment, the present invention provides a multiplexer that is NAL-aware. In other words, a multiplexer in accordance with the present invention understands the NAL type of video units and multiplexes them accordingly. This allows a multiplexer in accordance with the present invention to provide improved multiplexing of audio/video streams, such as H264/AVC streams.

An H264/AVC bit stream may contain different compressed frame types according to the profiles in use. For example, a baseline profile stream can have only I (Intra) and P (Predictive) frames whereas main and extended profile streams can have I, P and B (Bi-directional) frames. NAL units containing different frames will have different NAL type values. A partial listing of defined NAL type values is shown in Table 1 below (ITU-T Recommendation H264, Advanced video coding for generic audio visual services, May 2003.)

TABLE 1

| NAL type | Content of NAL Unit |
|---|---|
| 1 | Coded slice of a non-IDR picture |
| 5 | Coded slice of an IDR picture |
| 7 | Sequence Parameter set |
| 8 | Picture Parameter set |
| 13 . . . 23 | Reserved |

In any H264/AVC stream, an Instantaneous Decoding Refresh (IDR) picture is more important than non-IDR frames as far as the decoder is concerned. Moreover, Sequence Parameter sets and Picture Parameter sets are required for the correct decoding of an entire stream. As such, H264 decoders can conceal the errors caused by losing a ‘P’ frame or a ‘B’ frame better than errors caused by losing an IDR frame, and may be unable to decode a stream altogether by losing a Sequence Parameter set or a Picture Parameter set.

In an exemplary embodiment of the present invention, NAL type values 7 and 8 have the highest priority, followed by 5 and 1 and finally, 13-23. The range 13-23 can be further divided into Enhance IDR and Enhance non-IDR, with Enhance IDR having a higher priority.

A Scalable Video Coding (SVC) encoded bit stream will contain NAL units corresponding to multiple layers of encoding: for example, a base layer having low resolution frames and an enhancement layer having high resolution frames, in the case of spatial scalable coding. (See ISO/IEC 14496-10|ITU-T H.264-Annex G (2007), Scalable Video Coding.) In a typical spatial scalable coded stream, which has both base layer and enhancement layer NAL units, the base layer units can be considered more important than the enhancement layer NAL units since reproduction of video is possible only by decoding the base layer. Note that the base and enhancement layers can be sent in the same network stream or in different network streams.

The NAL type values in the range 13-23 can be used for sending enhancement layer NAL units in an SVC encoded bit stream. An enhancement layer NAL unit can thus be identified by looking at the NAL type value (i.e. 13-23). Different frame types within an enhancement layer of a SVC stream can use different NAL type values.

In an exemplary embodiment, the present invention provides a multiplexer that parses the NAL headers of units and determines their relative importance by looking at the NAL type values therein. The NAL-aware multiplexer can thus determine the NAL units that are more important for stream decoding. The multiplexer can then use this information to pass NAL units to its output accordingly. Thus, where bandwidth is limited, the multiplexer will pass all or some of the more important NAL units while dropping all or some of the less important NAL units.

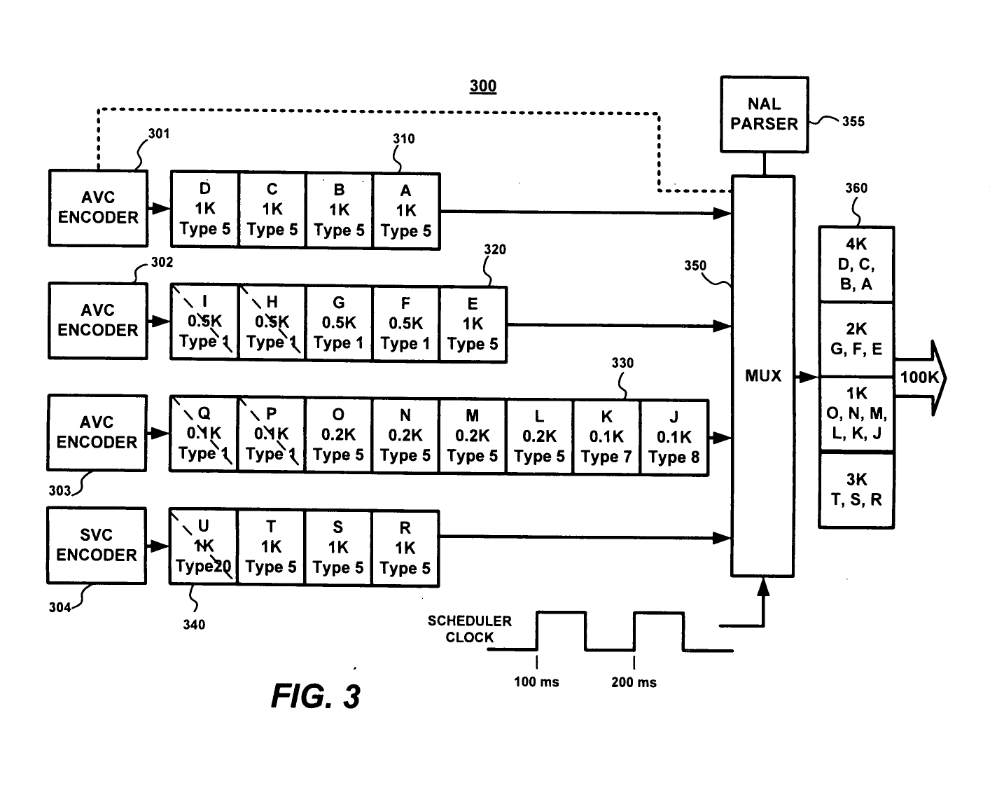

FIG. 3 is a block diagram of an exemplary embodiment of a multiplexer system 300 in accordance with the present invention. As shown in FIG. 3, the multiplexer system 300 comprises input buffers 310, 320, 330 and 340 in which incoming NAL units from different sources. AVC encoders 301, 302, 303 and SVC encoder 304 respectively, are pre-buffered. The input buffers 310, 320, 330 and 340 are preferably variable size buffers, which can change in size dynamically with the input. Although a four-input embodiment is shown for illustration, the present invention can be applied to embodiments with any number of input streams.

The input buffers 310, 320, 330 and 340 are coupled to a multiplexer (MUX) 350. A NAL parser 355 is coupled to the MUX 350, or may be incorporated into the MUX 350, to extract relevant information from the headers of NAL units. Alternatively, as indicated by the dotted line, the MUX 350 can communicate with an encoder 301-304 to obtain the relevant information for the stream generated by that encoder. The output of the MUX 350 is coupled to a channel buffer 360, also referred to as output buffer 360.

When a demand for higher bandwidth occurs for all input streams at the same time, the MUX 350 will look at the NAL unit types and NAL unit sizes to determine which one(s) to discard in order to fit the input streams into the available limited bandwidth. This determination will take into account the relative importance of NAL units within each input stream and across streams (in the case of SVC). The MUX 350 will also consider the NAL unit sizes. This way, the least significant NAL units will be discarded before the important ones, thereby lessening the impact on the quality of decoded video.

The operation of the exemplary multiplexer system 300 is illustrated in FIG. 3 with an exemplary scenario. In the exemplary scenario shown, the output buffer 360 is a 10 Kbit channel buffer feeding a 100 Kbps output channel. In accordance with a 100 ms scheduler clock, the MUX 350 can fill the channel buffer 360 every 100 ms to keep the output channel at its maximum capacity. FIG. 3 shows the contents of the input buffers 310, 320, 330 and 340 during a typical clock period. The input buffers 310-340 are re-filled every clock period from the respective sources 301-304. The size and type of each NAL unit (labeled A through U) in the buffers is shown. As shown in FIG. 3, the combined contents of the four input buffers is 12.2 Kbits, 2.2 Kbits more than the 10 Kbit size of the output buffer 360. In order to reconcile this difference, the MUX 350 will discard a set of NAL units containing a combined 2.2 Kbits or more. To do so, the MUX 350 will select the most important NAL units based on the NAL Type values and the sizes of the units to tit in the output channel. The MUX 350 will pass the selected NAL units to the output buffer 360 and discard the NAL units not selected.

In the example illustrated in FIG. 3, the MUX 350 discards NAL units H, I, P, Q and U, while passing on the remaining NAL units to the channel buffer 360. Note that because units F, G, H and I are the same size and type, the MUX 350 can select any two to discard. In the exemplary embodiment shown, the MUX 350 chooses to discard units H and I and pass units F and G because units F and G were buffered before units H and I, thus following a first-come-first-served rationale. Also, note that even though units J and K, for example, are the same size as units P and Q, which are discarded, units J and K, being type 8 and 7, respectively, are more important and thus passed on to the output buffer. In the case of the SVC stream from encoder 304, the MUX 350 chooses to discard unit U of the enhance layer (NAL Type 20) and passes units R, S and T of the base layer (NAL Type 5).

In an exemplary embodiment, the selection process carried out by the MUX 350 can be implemented, for example, using a set of rules with a table of mapping between NAL types and priority. Generally, the goal is for the more important data to get through the MUX.

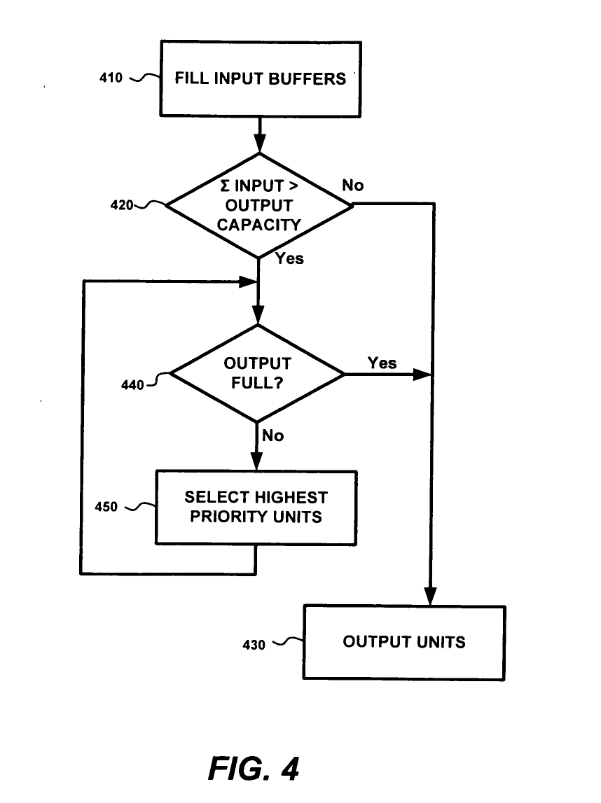

FIG. 4 is a flow chart illustrating the operation of an exemplary embodiment of the MUX 350. In this embodiment, for each scheduling clock period, the input buffers 310-340 are filled from their respective sources, as represented by step 410. At step 420, a determination is then made as to whether the collective contents of the input buffers 310-340 exceed the capacity of the output buffer 360. If not, the MUX 350, at step 430, passes the entire input buffer contents on to the output buffer. If, however, the collective contents of the input buffers 310-340 do exceed the capacity of the output buffer 360, a selection process is carried out, starting at step 450. At step 450 a series of selection passes are carried out in which NAL units in descending order of priority is selected for output until the output is full (e.g. highest priority are selected first). After each pass the remaining capacity of output is checked in step 440. Any units not selected up to that point are discarded. The process of FIG. 4 is repeated for each scheduling clock period.

Note that in the exemplary process of FIG. 4, NAL units from all four sources are selected without regard to their source. As such, it is possible that all units from a source will be discarded during any one scheduling clock period in favor of more important units from other sources. In a further exemplary embodiment, source can be taken into account in the selection process so as to ensure that a given minimum output bandwidth is allocated to one or more of the input streams. Thus, for example, if a given bandwidth is to be ensured for AVC Encoder 303, the MUX 350 can treat one or more units from said source as having higher priorities than they actually have when the MUX carries out its selection process.

It is understood that the above-described embodiments are illustrative of only a few of the possible specific embodiments which can represent applications of the invention. Numerous and varied other arrangements can be made by those skilled in the art without departing from the spirit and scope of the invention.

1. A method of multiplexing streams of data units comprising:
determining an importance of each of a plurality of data units in a plurality of input streams, wherein determining the importance of each of the plurality of data units includes identifying a content type of each data unit;
selecting a subset of the plurality of data units in accordance with the importance of each data unit; and
passing the subset of data units to an output stream.

2. The method of claim 1, wherein selecting the subset of the plurality of data units includes comparing the importance of data units in the same input stream and selecting the most important data units.

3. The method of claim 1, wherein selecting the subset of the plurality of data units includes comparing the importance of data units across two or more input streams and selecting the most important data units.

4. The method of claim 1, wherein the data units are Network Abstraction Layer (NAL) units, each NAL unit containing a header, the header containing the content type of the NAL unit.

5. The method of claim 4, wherein the content type of each NAL unit is identified by communicating with a source of each NAL unit.

6. The method of claim 1, wherein selecting the subset of the plurality of data units is performed in accordance with the importance and sizes of the data units.

7. The method of claim 1, wherein selecting the subset of the plurality of data units is performed when an aggregate bandwidth of the input streams is greater than a bandwidth of the output stream.

8. The method of claim 1, comprising:
buffering each of the plurality of input streams in a respective input buffer; and
buffering the output stream in an output buffer; and wherein selecting the subset of the plurality of data units is performed when a combined content of the input buffers is greater than a capacity of the output buffer.

9. The method of claim 1, wherein the input streams are at least one of an H264/AVC stream and an SVC stream.

10. Apparatus comprising:
a plurality of input buffers for buffering respective input streams of data units, each data unit having an associated content type;
a multiplexer for selecting buffered data units in accordance with their associated content type for transmission, the associated content type being representative of an importance of a data unit;
wherein the multiplexer selects buffered data units by comparing the importance of data units in the same input stream and selecting the most important data units.

11. The apparatus of claim 10, wherein the multiplexer selects buffered data units by comparing the importance of data units across two or more input streams and selecting the most important data units.

12. The apparatus of claim 10, wherein the data units are Network Abstraction Layer (NAL) units, each NAL unit containing a header, the header containing the content type of the NAL unit.

13. The apparatus of claim 10, comprising:
an NAL parser for extracting the associated content type for use by the multiplexer.

14. The apparatus of claim 10, wherein the multiplexer performs the selecting when an aggregate bandwidth of the input streams is greater than a bandwidth of an output stream of the multiplexer.

15. The apparatus of claim 10, wherein the input streams are at least one of an H264/AVC stream and an SVC stream.
